(19) United States
(12) Patent Application Publication
(10) Pub. No.: US 2010/0292955 A1
(43) Pub. Date: Nov. 18, 2010

(54) Method and Apparatus for Measuring Microrelief of an Object

(75) Inventors: John Toland Van Stan, II, Newark, DE (US); Matthew T. Jarvis, Newark, DE (US); Delphis F. Levia, JR., Elkton, MD (US)

Correspondence Address: RATNERPRESTIA, P.O. BOX 1596, WILMINGTON, DE, 19899, US

(73) Assignee: University of Delaware, Newark, DE (US)

(21) Appl. No.: 12/780,517

(22) Filed: May 14, 2010

Related U.S. Application Data
(60) Provisional application No. 61/178,708, filed on May 15, 2009.

(51) Int. Cl. G01B 11/14

(52) U.S. Cl. 702/159

(57) ABSTRACT

An apparatus for determining microrelief of an object periphery, comprising a ring for attachment to the object, a carriage adapted to traverse the ring; a non-contact measurement system mounted on the carriage; an advancement mechanism for incrementally advancing the carriage to a plurality of locations along the path; and a processor configured to receive and process an output of the measurement system. The processor determines a distance from the object periphery to the detector at each of the plurality of locations and automatically determines the microrelief of the object periphery from the measured distances. The apparatus and associated methods for determining microrelief may be particularly adapted to determine bark microrelief of trees, poles, pipes, or any other types of cylindrical objects.

### CROSS REFERENCE

This application claims priority to U.S. Provisional Application Ser. No. 61/178,708, filed May 15, 2009, which is incorporated herein, in its entirety, by reference.

### FIELD OF INVENTION

The invention generally relates to methods and systems for measuring the microrelief of objects, and is particularly suited for characterizing the periphery of cylindrical objects such as trees, telephone poles, and pipes.

### BACKGROUND OF THE INVENTION

“Bark microrelief” is a term used to refer to the configuration of the bark surface of a tree with respect to the spatial patterning of bark texture (i.e. the surface profile). Bark microrelief is inherently different among tree species and within tree species as a function of age. The variability in bark microrelief of individual trees is of great importance to the ecophysiological functioning of forest ecosystems. In particular, the distribution of corticolous lichens and bryophytes is partly governed by bark texture and bark water storage capacity which, in turn, directly and significantly affects stemflow yield and chemistry. Parmelia sulcata Tayl., for instance, demonstrated a significant association with bark ridges, whereas Physcia grisea Lam. exhibited a significant association with bark furrows. Quantification of bark microrelief is a challenging but important endeavor to better understand the functional ecology of forest ecosystems. This measure may be utilized to examine change in bark microrelief with disease, lichen growth, or diurnal changes due to stem dehydration. Trees infected with beech bark disease, for example, exhibit physical deviations in the bark surface. Recognizing the importance of bark microrelief to the distribution of lichen species, an instrument to quantify bark microrelief was designed in the late 1960's. The instrument designed and described by Yarranton 1967 consisted of a hinged aluminum ring manually screwed into a tree. A total of 180 hand measurements were collected around the circumference of sample tree boles, accounting for a measurement every 2°. Hitherto no instrument existed to characterize the inherent variability of bark microrelief with high spatial resolution.

### SUMMARY OF THE INVENTION

One aspect of the invention comprises a apparatus for determining microrelief of an object periphery, the apparatus comprising a ring for attachment to the object, the ring defining a path at a fixed distance from a central axis of the object; a carriage adapted to traverse the path defined by the ring; a non-contact measurement system mounted on the carriage; an advancement mechanism configured to incrementally advance the carriage to a plurality of locations along the path; and a processor configured to receive and process an output of the measurement system. The non-contact measurement system comprises a transmitter, such as a laser transmitter, adapted to transmit a beam of radiation toward the periphery of the object, and a detector, such as a CCD camera, adapted to detect at least a portion of the radiation reflected from the object. The processor is configured to process the measurement system output to determine a distance from the object periphery to the detector at each of the plurality of locations of the carriage along the path and to automatically determine the microrelief of the object periphery from the measured distances. The apparatus may be particularly adapted to determine bark microrelief of trees, poles, pipes, or any other types of cylindrical objects. The processor may be configured to provide an output in the form of a pictoral representation of the bark microrelief plotted in polar coordinates using the measured data provided by the measurement system.

The apparatus may further comprise a user interface and a power source connected to the processor. The same power source may also be connected to the measurement system and the advancement mechanism. The angle of incidence between the transmitter and the detector may be adjustable, and may be parallel or perpendicular to the plane of the ring. In one embodiment, the processor is programmed with instructions to cause the apparatus to perform the steps of (a) measuring the distance from the measurement system to the periphery of the object at a first location using the measurement system; (b) recording the distance from the measurement system to the periphery of the object in the processor memory; (c) incrementally advancing the carriage along the ring using the advancement mechanism; (d) repeating steps (a)-(c) until the carriage has fully traversed the ring; and (e) plotting the measured distances from the measurement system to the periphery of the object using polar coordinates to provide a pictoral representation of the bark microrelief.

Another aspect of the invention is a method for determining the microrelief of an object periphery, the method comprising the steps of (a) mounting a ring around the object at a fixed distance from a central axis of the object; (b) mounting on the ring a carriage containing a measurement system; (c) measuring, without contacting the object, a distance from the measurement system to the periphery of the object; (d) recording the distance from the measurement system to the periphery of the object; (e) incrementally advancing the carriage along the ring; and (f) repeating steps (c)-(e) until the carriage has fully traversed the ring. The method may further comprise (g) plotting the measured distances from the measurement system to the periphery of the object using polar coordinates to provide a pictoral representation of the bark microrelief.

### BRIEF DESCRIPTION OF THE DRAWINGS

FIG. 1 is a perspective view of the assembled ring, with support blocks, threaded anchors and carriage assembly.

FIG. 2 is an expanded perspective view of the assembled ring, with support blocks, threaded anchors and carriage assembly.

FIG. 3A is a perspective rear view of the carriage assembly.

FIG. 3B is a perspective front view of the camera frame.

FIG. 4A is a perspective front view of the carriage assembly with the camera frame mounted in the horizontal mounting position.

FIG. 4B is a perspective front view of the carriage assembly with the camera frame mounted in the vertical mounting position.

FIG. 5 is perspective rear view of the motor of the carriage assembly.

FIG. 6 is a flow chart of the method for measuring the range of the microrelief to the carriage assembly and then moving the carriage assembly to the next measurement point on the ring.

FIG. 7 is a polar plot comparing and validating results generated by an embodiment of the present invention using a laser rangefinder against manual measurements taken with digital calipers.

FIG. 8 is a polar plot generated by an exemplary embodiment of the present invention depicting the microrelief of an exemplary utility pole.

FIG. 9 is a polar plot generated by an exemplary embodiment of the present invention depicting the microrelief of a tree from the species Acer saccharinum.

FIG. 10 is a polar plot generated by an exemplary embodiment of the present invention depicting the microrelief of a tree from species Paulownia tomentosa.

### DETAILED DESCRIPTION OF THE INVENTION

Although illustrated and described herein with reference to specific embodiments, the invention is not intended to be limited to the details shown. Rather, various modifications may be made in the details within the scope and range of equivalents of the claims and without departing from the invention.

The present invention will be further described based on embodiments as examples, but embodiments of this invention are not limited to these examples. Additional embodiments of this invention may include, but are not limited to instruments for the measurement of the microrelief of the periphery of any object, such as, for example, the measurement of corrosion or deterioration of the exterior of a pipe, such as in a pipeline. While ideal for measurement of microrelief of the periphery of cylindrical or substantially cylindrical objects, the instrument described herein is not limited to specific types of measurements, specific objects to be measured, or specific periphery geometries.

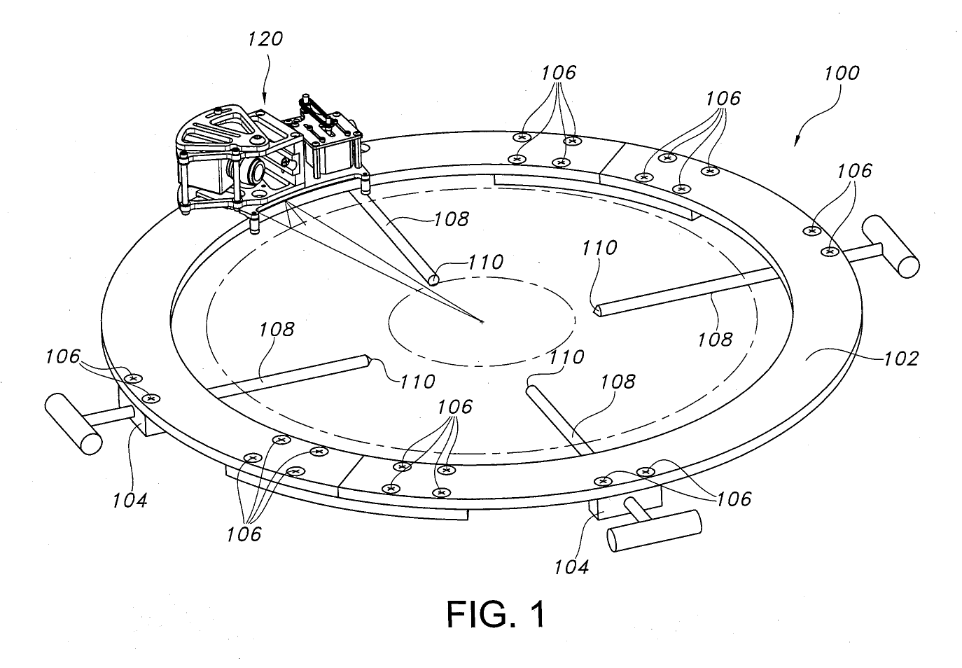

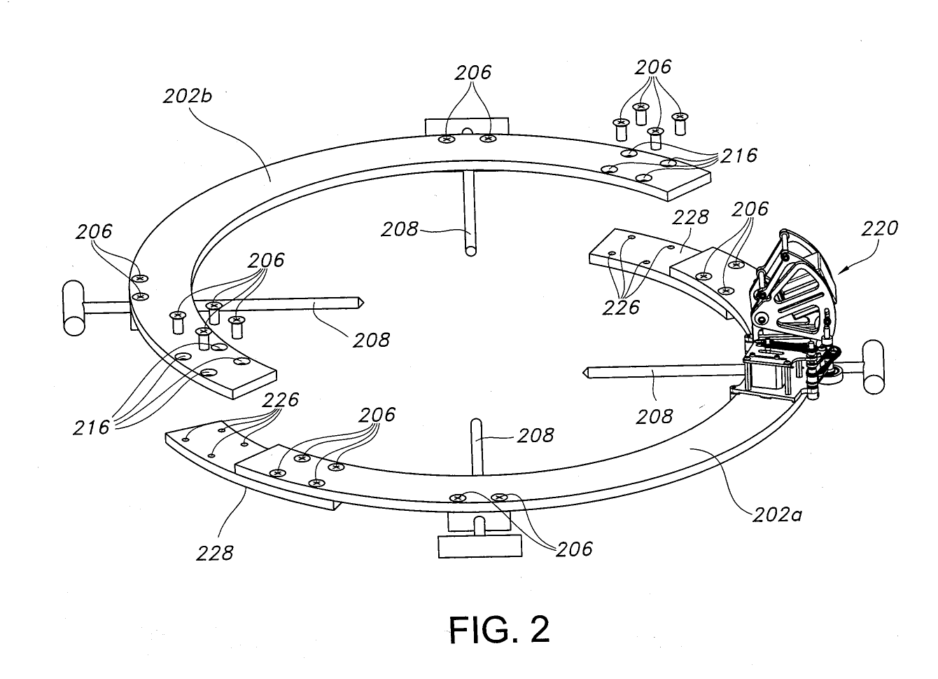

The instrument described herein provides a viable alternative for the quantification of microrelief. This instrument may be employed by scientists to better understand plant physiological ecology. As shown in FIG. 1, one embodiment of the invention comprises an instrument 100 for measuring microrelief. Instrument 100 generally comprises ring 102 which is removably attached to a tree or other object by radially adjustable anchors 108, such as threaded steel anchors attached to support blocks 104 connected to the ring. Ring 102 has at least two parts as shown in FIG. 2 to permit assembly around a tree or other elongated object. A carriage assembly 220, containing sensors for measuring distance from the carriage to the tree, is secured to and travels along the surface of ring 102.

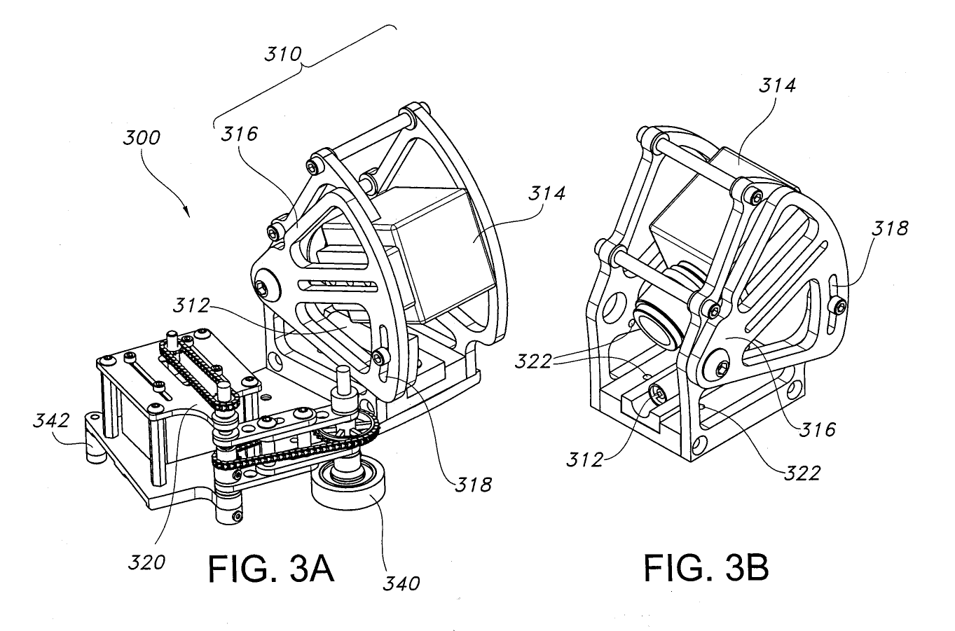

An exemplary carriage assembly 300 shown in FIG. 3A comprises a laser rangefinder 310 and a motor 320 to drive the carriage assembly 300 around the ring. Laser rangefinder 310 comprises a laser emitter 312 and a CCD sensor 314 with an optional computer interface. In one exemplary embodiment, CCD sensor 314 may comprise, for example, a monochrome machine vision camera with a ½ inch CCD sensor and a USB 2.0 interface, but the invention is not limited to any particular type or size of sensor. The optics may include, for example, a 12 mm fixed focal length lens with adjustable iris and red filter. In this exemplary embodiment, the laser emitter 314 comprised a diode laser with a power between 6 mW and 15 mW and a beam output at a 635 nm wavelength (visible red light). The laser may have an optional line generator.

In one exemplary arrangement, camera 314 is mounted to camera frame 316, as shown in FIGS. 3A and 3B, and laser 312 is mounted at the bottom of camera frame 316. Camera frame 316 allows for adjustment to the camera angle and camera adjustment slot 318 allows for an adjustment of the camera/laser offset, while protecting both the camera and the laser. The camera frame 316 may be mounted to the carriage assembly in multiple orientations through the threaded screw holes 322 in the chassis' lower plate and side plate

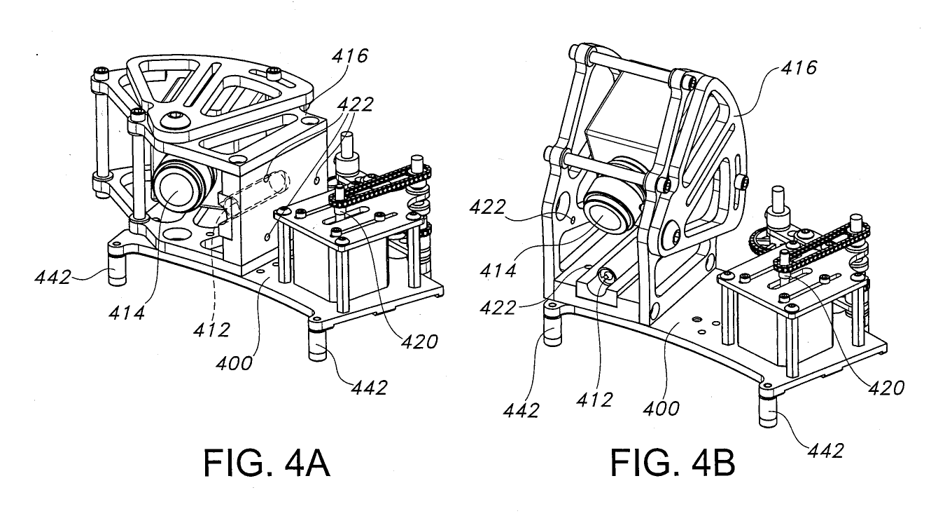

The camera frame 416 may be mounted on the carriage assembly 400 in a horizontal orientation as shown in FIG. 4A or a vertical orientation as shown in FIG. 4B. When mounted in the horizontal orientation, camera 414 is adjustable in the horizontal direction to permit adjustment of the horizontal angle between the camera 414 and the laser 412. Mounting the camera in the horizontal orientation requires the user to properly match the optics of the camera with the laser line generator 412. Upon proper matching of the optics, however, the horizontal orientation may provide the user with the ability to produce a three-dimensional scan of the microrelief of the intended target. Threaded screw holes 422 for mounting the camera frame 416 in the vertical position are depicted on the solid right hand side of the camera frame. In the horizontal mounting position, the angle of incidence between the optics 414 and the laser 412 is horizontal or parallel to the plane of the ring.

As shown in FIG. 4B, when mounted in the vertical orientation, camera 414 is adjustable in the vertical direction. This vertical adjustment permits vertical angle adjustment between the camera 414 and the laser 412. One of the threaded screw holes 422 for mounting the camera frame 416 in the horizontal position is depicted on the left-most wall of camera frame. In the vertical mounting position, the angle of incidence between the optics 414 and the laser 412 is vertical or perpendicular to the plane of the ring.

The laser emitter and the CCD sensor may be aligned such that the range to the target can be calculated through triangulation of the brightest pixel in the CCD image. The CCD sensor is secured in place by the camera frame 316,416, as shown in FIGS. 3A, 3B, 4A and 4B. The camera frame's function is to hold and adjust the CCD capture device and laser height during calibration procedures and operation. A servo motor device 320, 420 advances the camera frame 416 and carriage assembly 400 around the ring to collect the surface profile, such as bark microrelief data. The rangefinder is calibrated against a known scale and typically must be recalibrated if the emitter or CCD sensor is disturbed.

As described above, the laser rangefinder sits on a mobile carriage assembly. The carriage assembly may be aluminum or fiberglass chassis and may have a durable, waterproof plastic housing. The carriage assembly may be powered by, for example, a removable lithium-polymer or similar high density battery attached to the chassis and controlled by an on-board microcontroller. Aluminum “undriven” (non-powered) wheels 342, 442 are pinned such that they ride on the inner diameter of the ring, holding the carriage in alignment as it travels around the tree. The laser emitter and CCD sensor, which together make up the rangefinder hardware, are precisely located on machined features such that they always point at the central axis of the ring.

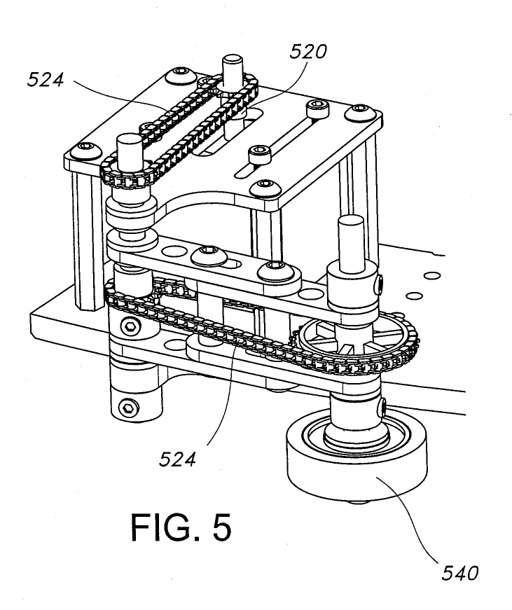

As shown in FIG. 5, the carriage assembly 500 also consists of a motor 520 to drive the carriage assembly 500 around the aluminum ring. In one exemplary embodiment, motor 520 comprised a 4 W, 0.23N-m bipolar stepper motor with a 3:1 drive, a mini acetal chain 524, and an undamped arm suspension. The carriage is moved around the ring by a “driven” traction wheel 540 which presses against the outer diameter of the ring and is driven around the circumference of the ring by a USB-controlled servo motor through a transmission and suspension assembly. The electronics of the motor system, including the motor controller, the battery and the interference switches which may be housed in a separate case and connected to the carriage assembly by a cable (not pictured).

When in use, the entire apparatus may be driven by a controller/processor (not shown), such as a laptop computer, personal digital assistant (PDA), or a dedicated interface device containing data storage. The entire apparatus and may draw power from the laptop's battery, the PDA's battery, a power source within the dedicated interface device, or a power source located on the carriage assembly. The system is not limited to any particular type of power source, data transfer connection, or processor type.

Ring 102 may comprise, for example, machined aluminum with steel support blocks 104, but is not limited to any particular materials of construction. Ring 102 typically has a diameter suitably larger than the objects desired for measurement and has a thickness suitable for providing rigidity and stability while supporting the ring and carriage assembly. A prototype machined aluminum ring was constructed having an outer diameter of 84 cm and a thickness of 1.27 cm.

As shown in FIG. 2, ring 202 typically comprises at least two halves 202a and 202b. The halves of the ring are typically connected to one another, and the anchors 208 connected to the rings, by fasteners 216, such as steel threaded fasteners, that protrude through the ring 202 into the support blocks 204. Fasteners 206, such as threaded fasteners, extend through fastener holes 216 in ring 202 and into corresponding threaded holes 226 in attachment plates 220. The invention is not limited to any particular type of fastener. The holes for the fasteners may be countersunk so the heads of the fasteners 106 do not protrude above the upper surface of the aluminum ring 102 and interfere with the operation and movement of the carriage assembly 120.

Once the aluminum ring 202 has been completely assembled, threaded anchors 208 may be adjusted to secure the aluminum ring 202 to the tree. Anchors 108 are typically sharpened at their distal ends 110 and are thin enough to avoid interfering with bark surface measurements at input positions, but thick enough to securely anchor ring 102 and any corresponding instrumentation to the tree. The thickness and materials of construction of the anchors are chosen not only to enable support of the instrument but also to prevent deformation while attached to the tree.

One embodiment, not pictured, may comprise a kit comprising the carriage assembly and related control and processing electronics as described herein, in combination with a series of rings of varying diameters, preferably machined from aluminum or molded from lightweight fiberglass. The rings may have a difference of approximately six inches between their inner and outer diameters, and may come in an increment of sizes beginning at roughly 15 inches in the inner diameter and reaching as large as 30 or 40 inches in the inner diameter. Such a kit will permit use of the measurement apparatus in connection with trees or other objects of varying diameter.

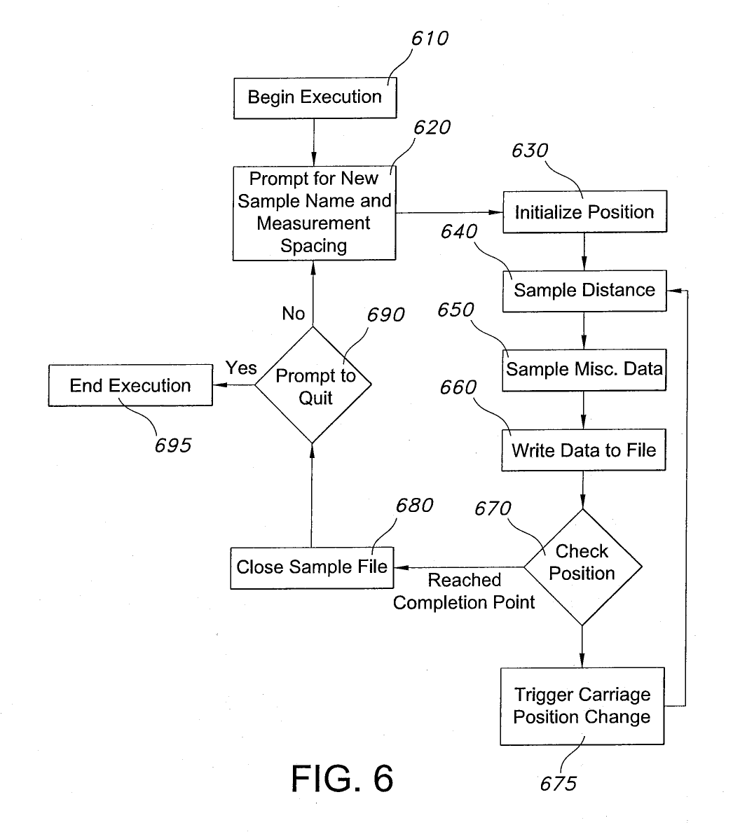

To operate the system, the ring is attached to the tree, the carriage placed at an arbitrary starting point, and the apparatus activated. The controller/processor causes the motor to move the carriage around the ring while the laser diode or line generator projects a beam or line onto the object in the center of the ring to be measured. The camera captures image data from the measurement region, and the controller/processor triangulates the range to the object through the location of the laser light in the image data. This image data is then transmitted back to the controller/processor and stored. The servo motor drives the carriage around the ring incrementally while taking and recording a distance measurement at each increment, pursuant to the flowchart shown in FIG. 6, until the entire circumference has been traversed and sampled.

The flowchart shown in FIG. 6 represents the steps of an exemplary process programmed as instructions executed by the controller/processor for measurement of the microrelief of an object using the instrument described herein. The processor begins execution of the process at step 610 and prompts the user to provide a new sample name and measurement spacing in step 620. The processor initializes the position of the carriage assembly in step 630. Once the position has been initialized, a sample distance is measured (step 640), data such as distance to bark, pipe, or pole surface from the inner ridge of the ring is measured (step 650), and the measured data is written to a file (step 660). The processor checks to determine if the carriage assembly has completed a full circle around the ring (step 670), and if not, increments the carriage position (step 675) and returns to step 640. Once the carriage assembly completes its movement around the ring, the controller/processor saves and closes the sample file (step 680) and prompts the user to quit or continue taking measurements (step 690). If the user answers the prompt to quit in the negative, the processor returns to step 620 and executes the above process again. If the user answers the prompt to quit in the affirmative, the processor continues to step 695 and ends execution of the program.

For distance measurement using a triangulation methodology, the controller/processor receives images from the sensor, finds the brightest pixel, and triangulates distances from it. As measurement depends on the laser point containing the brightest pixel, it may be preferable to shield the measurement area from any sources of bright or direct light during operation. To ensure consistent measurements of bark microrelief, it may be preferable to use the instrument under uniformly overcast skies to minimize subcanopy radiation flux that may interfere with the camera recognizing the laser signal. The ring of the invention should preferably be positioned orthogonal to the tree using a level, to ensure accurate and precise measurements.

The carriage assembly may be connected to the controller/processor via a hardwired connection or a wireless connection. Both the motor and the camera may be connected to the laptop, PDA or dedicated interface device through independent USB cables, which may need to be kept from tangling or pulling out. In the alternative, wireless connections and an independent power source connected to the carriage may be provided. In one embodiment, using an RF link or similar wireless telemetry device, a microcontroller residing on the carriage may transmit the range and incremental position to a nearby interface device being used by the operator. The interface device may include a processor capable of receiving the data, correcting for the ring size and range to target, and plotting the data on the screen for the operator as it is being received. The interface device may then save the data and the plot when the measurement is complete.

In alternative embodiments, other methods of calculation may be used to determine the range of the target, including but not limited to single laser time of flight, scanning beam laser triangulation, scanning beam laser time of flight, structured light, motorized touch probe, ultrasonic/infrared ranging, binocular stereo depth mapping, optic flow mapping, photogrammetric coordinate measurement, or any other method of calculation for an automated distance measurement that is known in the art.

In one experimental example, the data corresponding to the range measurements made by the device were saved in the form of raw, comma-delimited ASCII files. Each entry recorded included the laser rangefinder's triangulation distance and the position on the ring. A computer was used to process the data by subtracting the rangefinder measurements from the ring diameter and plotting the result in polar coordinates. A ±1° mean-point filter was then applied to reduce noise in the data while preserving the shape of the surface. The software used for processing the data also allowed the operator to perform a quick visual check to make sure the data was complete before disassembling the ring from the tree. Typical operation of the invention will provide a detailed cross section of the tree bole in less than fifteen minutes, including instrument set-up.

Sampling resolution is important for quantifying bark microrelief. If the tree bole profile is thought of as a discrete signal, the Nyquist frequency is the critical sampling frequency which must be met or exceeded in order to capture all components of the system. The Nyquist frequency is defined as double the maximum frequency component of the system. In distance-based signal systems, like a tree bole profile, this means that the spacing between sampling points should be half of the width of the smallest ridge the instrument is intended to capture. For a tree bole cross-section, as measured by the instrument described by Yarranton, the angular distance between sampling points is 2°. Thus, the narrowest ridge Yarranton can theoretically detect is 4° around the instrument's central axis. For a 10 cm diameter tree, the most narrow measurable ridge is 0.34 cm, while a 40 cm diameter tree's most narrow measurable ridge is 1.4 cm. The disclosed invention reads a measurement every 0.33°, making it possible to measure ridges 6 times smaller than the Yarranton design. Using a laser rangefinder and a servo motor and controller for positioning shortens data collection time and enhances data quality by reducing opportunity for human error. Computer-controlled positioning allows for increased sampling resolution without increasing the human effort needed in the data collection process. Furthermore, this instrument can be utilized to record tree bole cross sections in multiple locations along the trunk, providing some element of three-dimensionality in the estimation of bark surfaces.

Thus, embodiments of the present invention differ significantly from the Yarranton device as summarized in the following table:

| | Embodiments of | |
|---|---|---|
| Property | Present Invention | Yarranton device |
| Measurement mode | automated | manual |
| Measurement interval | variable | 2° |
| Distance measurement | triangulation | linear manual measurement |
| method | | |
| Capable of measuring | yes | no |
| areas between humps/ | | |
| hollows | | |
| Narrowest measureable | 0.33° | 4° |
| ridge | | |

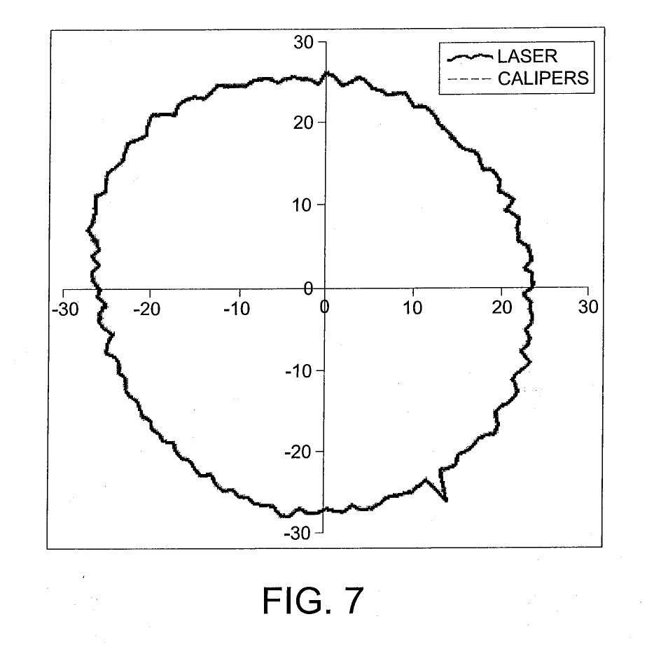

A polar graph comparing measurements of bark microrelief between the automated instrument and the digital calipers demonstrates that the instrument provides a robust and accurate measure of bark microrelief with a mean absolute error of only 0.83 mm as shown in FIG. 7. The disclosed invention yields a better measure of bark microrelief than digital calipers, especially in bark furrows where the digital calipers cannot reach full furrow depth.

One measure of quantitative bark microrelief is the ratio of a tree bole's estimated bark area (cm²) (the path length of the cross-section multiplied by the thickness of the bark) to cross sectional area (cm²) (the area occupied by the tree bole). The path length cross section is acquired by the instrument described herein and bark thickness can be acquired by a standard bark thickness gauge. This measure of bark microrelief has utility to a broad scientific community as it provides a meaningful metric to gain a more holistic understanding of the functional ecology of forest ecosystems.

Validation data demonstrates that the disclosed invention is accurate to <1 mm. Polar resolution is 0.33°, which is roughly 2 mm along the prototype ring. This is a greater resolution than can be achieved by hand. Because of this enhanced resolution and measurement accuracy, data provided by this instrument for measuring bark microrelief supplies researchers with a level of characterization that has been previously unavailable.

### EXAMPLES

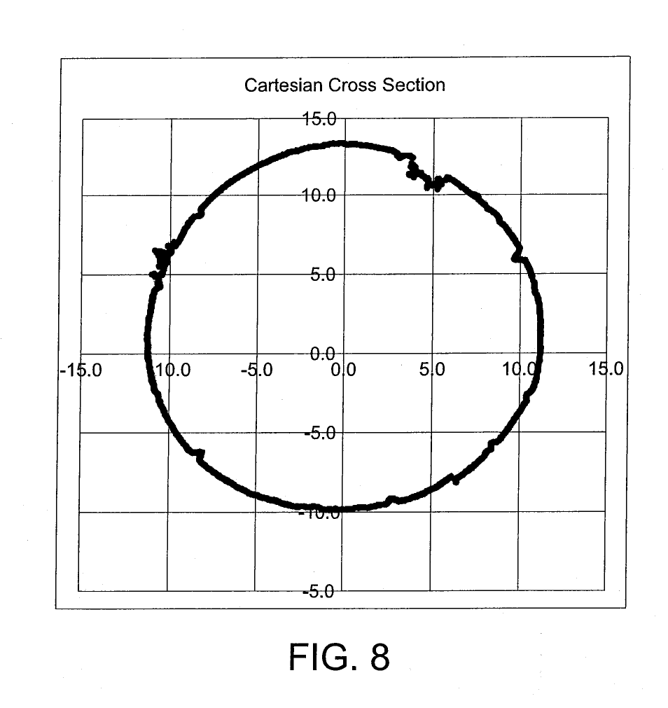

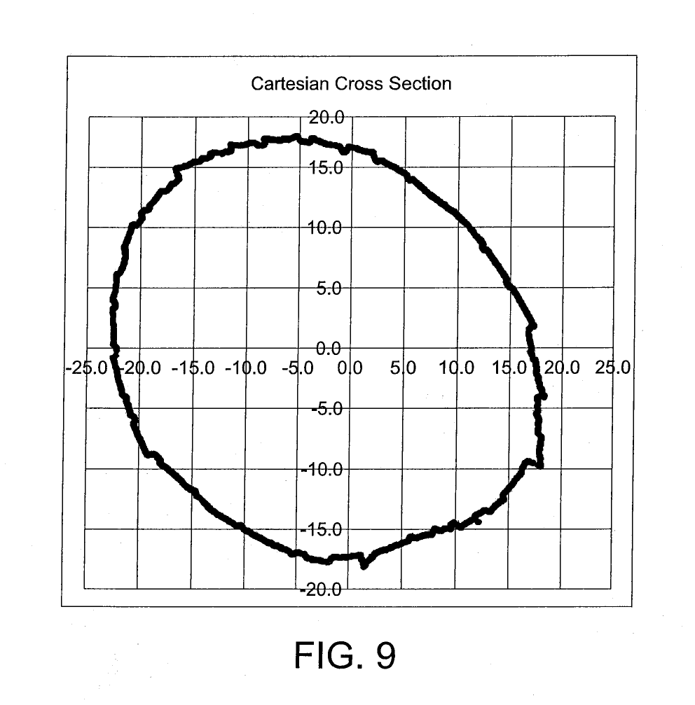

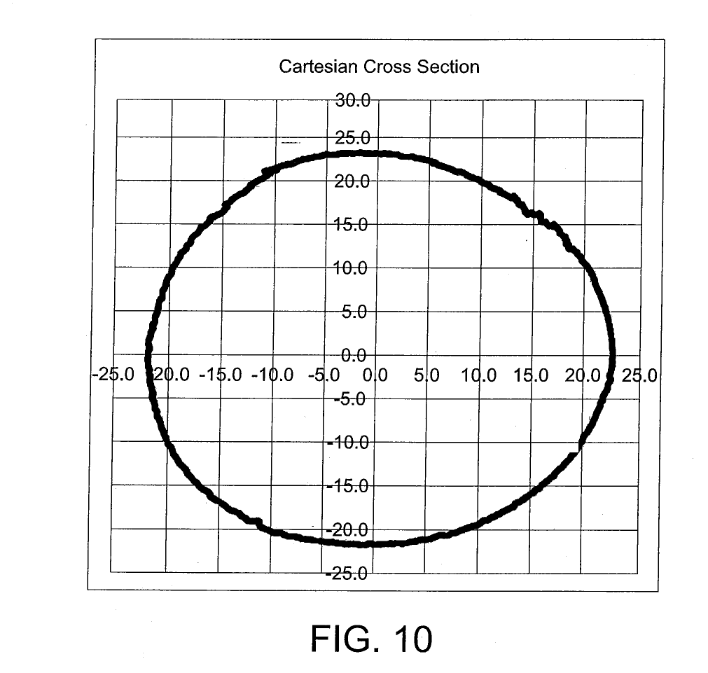

The instrument for measuring bark microrelief was validated on several utility poles and several species of trees. As shown in FIGS. 8-10, the resulting plots of several of these runs are revealed. FIG. 8 shows the results of a fairly worn utility pole. The utility pole has a diameter of roughly 24 inches and as shown in the plot contains several locations where the pole has experienced degradation of this diameter. FIG. 9 shows the results of a microrelief measurement taken for the species Acer saccharinum, also known more commonly as a silver maple. As shown in the plot, the trunk for this particular sample takes on an oblong shape ranging from 34-40 inches in diameter. The microrelief of the bark shows some damage and scarring which may be used as an indicator of tree health and age. Finally, FIG. 10 shows the results of a microrelief measurement taken for the species Paulownia tomentosa, also known more commonly as an Empress tree. As shown in the plot, the trunk for this particular sample takes on a relatively circular shape at about 44 inches in diameter. The microrelief of the bark shows relatively minimal damage or scarring, thereby indicating a healthy bark microrelief for the tree.

What is claimed:

1. An apparatus for determining microrelief of an object periphery, the apparatus comprising:
a ring for attachment to the object, said ring defining a path at a fixed distance from a central axis of the object;
a carriage adapted to traverse the path defined by the ring;
a non-contact measurement system mounted on the carriage, the non-contact measurement system comprising a transmitter adapted to transmit a beam of radiation toward the periphery of the object, and a detector adapted to detect at least a portion of the radiation reflected from the object;
an advancement mechanism configured to incrementally advance the carriage to a plurality of locations along the path; and
a processor configured to receive and process an output of the measurement system to determine a distance from the object periphery to the detector at each of the plurality of locations of the carriage along the path and to automatically determine the microrelief of the object periphery from the measured distances.

2. The apparatus of claim 1, wherein the object is a tree and the apparatus is adapted to determine bark microrelief of the tree.

3. The apparatus of claim 1, wherein the object is a pole and the apparatus is adapted to determine the microrelief of the pole.

4. The apparatus of claim 1, wherein the object is a pipe and the apparatus is adapted to determine the microrelief of the pipe.

5. The apparatus of claim 1 wherein the processor is connected to the measurement system via wires.

6. The apparatus of claim 1 wherein the processor is wirelessly connected to the measurement system.

7. The apparatus of claim 1, wherein the processor comprises a memory for storage of the measured data provided by the measurement system.

8. The apparatus of claim 1, wherein the processor is configured to provide an output in the form of a pictoral representation of the bark microrelief plotted in polar coordinates from the measured data provided by the measurement system.

9. The apparatus of claim 1 wherein the processor is configured to instruct the advancement mechanism to move the carriage incrementally along the path defined by the ring.

10. The apparatus of claim 1, further comprising a user interface and a power source connected to the processor.

11. The apparatus of claim 10, wherein the power source is also connected to the measurement system and the advancement mechanism.

12. The apparatus of claim 1, wherein the transmitter comprises a laser.

13. The apparatus of claim 1, wherein the detector comprises a CCD camera.

14. The apparatus of claim 1, comprising means for adjusting an angle of incidence between the transmitter and the detector.

15. The apparatus of claim 1, wherein the ring defines a plane and the transmitter and the detector define an angle of incidence parallel to the plane of the ring.

16. The apparatus of claim 1, wherein the ring defines a plane and the transmitter and the detector define an angle of incidence perpendicular to the plane of the ring.

17. The apparatus of claim 1, wherein the processor is programmed with instructions to cause the apparatus to perform the steps of:
(a) measuring the distance from the measurement system to the periphery of the object at a first location using the measurement system;
(b) recording the distance from the measurement system to the periphery of the object in the processor memory;
(c) incrementally advancing the carriage along the ring using the advancement mechanism;
(d) repeating steps (a)-(c) until the carriage has fully traversed the ring; and
(e) plotting the measured distances from the measurement system to the periphery of the object using polar coordinates to provide a pictoral representation of the bark microrelief.

18. A method for determining the microrelief of an object periphery, said method comprising the steps of:
(a) mounting a ring around the object, said ring mounted a fixed distance from a central axis of the object;
(b) mounting on the ring a carriage containing a measurement system;
(c) measuring, without contacting the object, a distance from the measurement system to the periphery of the object;
(d) recording the distance from the measurement system to the periphery of the object;
(e) incrementally advancing the carriage along the ring; and
(f) repeating steps (c)-(e) until the carriage has fully traversed the ring.

19. The method of claim 18 further comprising the step of:
(g) plotting the measured distances from the measurement system to the periphery of the object using polar coordinates to provide a pictoral representation of the bark microrelief.
